(19) United States
(12) Patent Application Publication
(10) Pub. No.: US 2013/0043438 A1
(43) Pub. Date: Feb. 21, 2013

(54) ANTISTATIC OR SEMI-CONDUCTIVE POLYURETHANE ELASTOMERS

(71) Applicants: Bob Malcolm Moss, Glossop (GB); Ian Robert Mycock, High Peak (GB); Andrew M. Davies, Ashton-Under-Lyne (GB)

(72) Inventors: Bob Malcolm Moss, Glossop (GB); Ian Robert Mycock, High Peak (GB); Andrew M. Davies, Ashton-Under-Lyne (GB)

(73) Assignee: Dow Global Technologies LLC, Midland, MI (US)

(21) Appl. No.: 13/583,330

(22) PCT Filed: Mar. 9, 2011
(86) PCT No.: PCT/US11/27629

§ 371 Date: Sep. 7, 2012

Related U.S. Application Data
(60) Provisional application No. 61/316,079, filed on Mar. 22, 2010.

(51) Int. Cl. H01B 1/24; B82Y 40/00; B82Y 30/00

(52) U.S. Cl. 252/511; 977/788; 977/840

(57) ABSTRACT

A polyurethane elastomer showing desirable conductivity properties comprises at least 0.3 percent by weight of an aggregated particulate carbon black, having a particle size of less than or equal to 100 nanometers, that forms a continuous conductive pathway within the polyurethane elastomer. The polyurethane elastomer may exhibit a surface resistivity ranging from 1×10⁴ to 1×10⁸ ohms. It may be made by first preparing an isocyanate-terminated prepolymer containing the carbon black, the prepolymer having a volume resistivity of from 1×10⁴ to 1×10⁸ ohms, and then reacting the isocyanate-terminated prepolymer with an isocyanate-reactive component. The proportion of the prepolymer ensures that it forms a continuous phase in the final elastomer.

### BACKGROUND

1. Field of the Invention

This invention relates to polyurethane elastomers that are electrically conductive. More particularly, the invention relates to polyurethane elastomers that enable static discharge through a designed structure that provides and maintains a conductive pathway while a two-phase elastomer forms.

2. Background of the Art

Polyurethane elastomers have gained a unique position in engineering applications due to their ability to combine elastomeric properties with high abrasion and tear resistance. This has enabled these materials to be used in equipment having a load-bearing face that must be capable of rigorous and/or prolonged service. Because such a surface is being rapidly contacted during such use, there is frequently a build-up of static charge that must be discharged through earthing devices in order to avoid the danger of electrocution of the equipment operator.

That discharge function is frequently helped by ensuring that the elastomer is rendered antistatic. This requires modification of the material to allow conduction of electricity to the earthing point. This modification has frequently been provided by including in the elastomer additives that provide electron transport assuming a continuous conductive pathway is maintained.

One approach has been to use quarternary ammonium salts and hydrophilic agents to the elastomer. In this case resistivity values as low as 10⁸ ohms have been achieved. However, industries that employ antistatic elastomers require surface resistivity values from 1×10⁴ to 1×10⁸ ohms, which are more appropriate to ensure that adequate discharge is achieved.

Another approach has been to use metallic and/or carbon black fillers to improve electrical conductance. Unfortunately, it has been difficult to guarantee a conductive pathway for polyurethane elastomers because of their unique two-phase morphology.

Thus, there remains a need in the art for polyurethane elastomers that may be dependably prepared to have conductive and antistatic properties.

### SUMMARY OF THE INVENTION

In one embodiment, the invention provides a semi-conductive polyurethane elastomer, comprising at least 0.3 percent by weight of an aggregated particulate carbon black, having an average particle diameter that is less than or equal to 100 nanometers, that forms a conductive pathway within the polyurethane elastomer, the polyurethane elastomer having been prepared by incorporating the aggregated particulate carbon black into an isocyanate-terminated prepolymer, such that the polyurethane elastomer has a surface resistivity of from 1×10⁴ to 1×10⁸ ohms (10⁻⁴ to 10⁻⁸ siemens (mho)). In preferred embodiments the carbon black is Ketjenblack™ EC-600JD, Ketjenblack™ EC-330JMA, or a combination thereof. Ketjenblack™ is a tradename of Akzo Nobel Chemicals.

In another embodiment, the invention provides a process for preparing a semi-conductive polyurethane elastomer comprising the steps of (a) preparing an isocyanate-terminated prepolymer wherein at least 0.3 percent by weight of an aggregated particulate carbon black, having an average particle diameter that is less than or equal to 100 nm, is incorporated in the prepolymer, the prepolymer having a volume resistivity of from 1×10⁴ to 1×10⁸ ohms; and (b) reacting the isocyanate-terminated prepolymer and an isocyanate-reactive component to form a semi-conductive polyurethane elastomer; the isocyanate-terminated prepolymer and the isocyanate-reactive component being in proportions such that the isocyanate-terminated prepolymer forms a continuous phase and the isocyanate-reactive component forms a discontinuous phase; under conditions such that the aggregated particulate carbon black forms a conductive pathway in the polyurethane elastomer.

### DETAILED DESCRIPTION OF THE EMBODIMENTS

The invention provides antistatic and/or semi-conductive elastomers that may be useful for a variety of purposes, and which may also include additional desirable properties, such as desirable levels of abrasion and tear resistance. The polyurethane is generally a two-component polyurethane elastomer, prepared beginning with an isocyanate-terminated prepolymer which is then reacted with an isocyanate-reactive component. The polyurethane as a whole has a surface resistivity value ranging from 1×10⁴ to 1×10⁸ ohms This surface resistivity is attributable to a dispersed, percolated carbon black structure that forms a conductive pathway through the elastomer to enable static discharge. As the term is used herein, “percolated” means that the carbon black particles are present in a concentration such that the given polyurethane sample is capable of conducting electricity from any one surface to its opposing surface. Thus, the invention is useful for both engineering elastomers and for components requiring static dissipation, such as instrument casings.

A key component included in the formulation, forming the dispersed, percolated carbon black structure, is a carbon black that is an aggregated particulate, with a particle size less than or equal to 100 nanometers (nm). By “aggregated” it is meant that the particles are, in their pre-formulation state, actually interconnected, and this interconnection is sufficiently tight that the particles are not separated by the shear forces that are applied during formulation. They therefore remain interconnected within the prepolymer and, as a result both of their interconnection and of the concentration of the carbon black, in the final formulation. Examples of suitable particulate carbon blacks may include products designated as Ketjenblack™ EC-600JD and Ketjenblack™ EC-330JMA, available from AkzoNobel Polymer Chemicals. Of these, Ketjenblack™ EC-600JD is, in certain embodiments, more preferred. Such products may have particle sizes in the range of, for example, from 30 nm to 100 nm Additional properties that may be useful in the selected carbon black may include at least one of an apparent bulk density of less than 200 kilograms per cubic meter (kg/m³), a pore volume of at least 300 milliliters per 100 grams (mL/100 g), an iodine absorption of at least 700 milligrams per gram (mg/g), and a Brunauer, Emmett, Teller (BET) surface area of at least 800 square meters per gram (m²/g).

The polyurethane elastomers of the invention comprising an isocyanate group-containing component (hereinafter “isocyanate-terminated component”) and an isocyanate-reactive component (hereinafter “isocyanate-reactive component”). In certain preferred embodiments, it may be a block copolymer-type elastomer. In order to prepare the polyurethane elastomer, it is necessary to react the isocyanate-reactive component with the isocyanate-terminated component. Suitable polyisocyanates may be aliphatic, cycloaliphatic, araliphatic, or aromatic polyisocyanates, or combinations thereof. Such may include, for example, alkylene diisocyanates, particularly those having from 4 to 12 carbon atoms in the alkylene moiety, such as 1,12-dodecane diisocyanate, 2-ethyltetramethylene 1,4-diisocyanate, 2-methyl-pentamethylene 1,5-diisocyanate, 2-ethyl-2-butylpentamethylene 1,5-diisocyanate, tetramethylene 1,4-diisocyanate and preferably hexamethylene 1,6-diisocyanate; cycloaliphatic diisocyanates, such as cyclohexane 1,3- and 1,4-diisocyanate and any desired mixture of these isomers, 1-isocyanato-3,3,5-trimethyl-5-isocyanato-methylcyclohexane (isophorone diiso-cyanate), 2,4- and 2,6-hexahydrotolylene diisocyanate, and the corresponding isomer mixtures, 4,4-, 2,2′- and 2,4′-dicyclohexylmethane diisocyanate and the corresponding isomer mixtures, araliphatic diisocyanates, e.g., 1,4-xylylene diisocyanate and xylylene diisocyanate isomer mixtures, and preferably aromatic diisocyanates and polyisocyanates, e.g., 2,4- and 2,6-tolylene diisocyanate and the corresponding isomer mixtures, 4,4′-, 2,4′- and 2,2′-diphenylmethane diisocyanate and the corresponding isomer mixtures, mixtures of 4,4′- and 2,4′-diphenylmethane diisocyanates, polyphenyl-polymethylene polyisocyanates, mixtures of 4,4′-, 2,4′- and 2,2′-diphenylmethane diisocyanates and polyphenyl-polymethylene polyisocyanates (crude MDI), and mixtures of crude MDI and tolylene diisocyanates. The organic diisocyanates and polyisocyanates may be employed individually or in the form of combinations thereof. The isocyanate component is, in certain particular embodiments, desirably a prepolymer, i.e., a urethane-modified polyisocyanate, and in other non-limiting embodiments is a urethane-modified aromatic polyisocyanate such as a prepolymer prepared from 4,4′-diphenylmethane diisocyanate.

The organic polyisocyanates may be prepared by known processes. They are preferably prepared by phosgenation of the corresponding polyamines with formation of polycarbamoyl chlorides, followed by thermolysis of the polycarbamoyl chlorides to produce the organic polyisocyanate and hydrogen chloride. Alternatively, they may be prepared by phosgene-free processes, such as, for example, by reacting the corresponding polyamines with urea and alcohol to give polycarbamates, followed by thermolysis of the polycarbamates to produce the polyisocyanate and alcohol.

Where the polyisocyanates are to be modified, groups such esters, ureas, biurets, allophanates, uretoneimines, carbodiimides, isocyanurates, uretidiones and/or urethanes are added thereto. One example product is a urethane-containing organic, preferably aromatic, polyisocyanate containing from 33.6 to 15 percent by weight, preferably from 31 to 21 percent by weight, of NCO, based on the total weight. Preparation begins with 4,4′-diphenylmethane diisocyanate, 4,4′- and 2,4′-diphenylmethane diisocyanate mixtures, or crude MDI or 2,4- or 2,6-tolylene diisocyanate, which are then modified by means of reaction with diols, triols, dialkylene glycols, trialkylene glycols or polyoxyalkylene glycols having molecular weight of up to 6,000. Specific examples of di- and polyoxyalkylene glycols, which may be employed individually or as mixtures for this purpose, are diethylene, dipropylene, polyoxyethylene, polyoxypropylene and polyoxy-propylene-polyoxyethylene glycols, triols and/or tetrols. NCO-containing prepolymers containing from 25 to 3.5 percent by weight, preferably from 21 to 14 percent by weight, of NCO, based on the total weight, may be prepared from the polyether polyols described hereinabove reacted with 4,4′-diphenylmethane diisocyanate, mixtures of 2,4′- and 4,4′-diphenylmethane diisocyanate, 2,4- and/or 2,6-tolylene diisocyanates or crude MDI. Furthermore, liquid polyisocyanates containing carbodiimide groups and/or isocyanurate rings and containing from 33.6 to 15 percent by weight, preferably from 31 to 21 percent by weight, of NCO, based on the total weight, e.g., based on 4,4′-, 2,4′- and/or 2,2′-diphenylmethane diisocyanate and/or 2,4′ and/or 2,6-tolylene diisocyanate, may also be selected.

The modified polyisocyanates may be mixed with one another or with unmodified organic polyisocyanates, such as, for example, 2,4′- or 4,4′-diphenylmethane diisocyanate, crude MDI, and/or 2,4- and/or 2,6-tolylene diisocyanate. An isocyanate component frequently employed in the shoe sole industry may be prepared by reacting a monomeric 4,4′ methane-diisocyanate; an ethylene oxide-capped diol having a molecular weight of 4000; an ethylene oxide-capped triol having a molecular weight of 6000; and a second chain extender including dipropylene glycol, tripropylene glycol, or a mixture thereof; under conditions suitable to form a prepolymer. This prepolymer is then reacted with a polyol component and a blowing agent to make the final polyurethane foam.

Organic polyisocyanates which may also be particularly successful may further include mixtures of modified organic polyisocyanates containing urethane groups, having an NCO content of from 33.6 to 15 percent by weight, in particular those based on tolylene diisocyanates, 4,4′-diphenylmethane diisocyanate, diphenylmethane diisocyanate isomer mixtures or crude MDI, in particular 4,4′-, 2,4′- and 2,2′-diphenylmethane diisocyanate, polyphenyl-polymethylene polyisocyanates, 2,4- and 2,6-tolylene diisocyanate, crude MDI having a diphenylmethane diisocyanate isomer content of from 30 to 80 percent by weight, preferably from 35 to 45 percent by weight, and mixtures of at least two of the above-indicated polyisocyanates, for example, crude MDI or mixtures of tolylene diisocyanates and crude MDI.

The second major component of the inventive elastomer formulation is an isocyanate-reactive component. This may include one or more materials containing terminal groups that react with isocyanate groups, including but not limited to hydroxyl groups, amine groups; thiol groups; sulfhydryl groups; and combinations and hybrid species thereof. The isocyanate-reactive component is hereafter generally termed, for convenience as well as convention, as the “polyol,” regardless of whether a formulation contains only one compound, or two or more compounds. In certain embodiments the polyol has a functionality of from 2 to 8, preferably from 2 to 4. Viscosity may vary, according to dictates relating to formulation, availability, practicality, and/or equipment

Examples of the polyols which may be included in the system are polyether polyols, polyester polyols, polyamines, polyether-ester polyols, polycaprolactones, polycarbonates, copolymers thereof, and combinations thereof. Other examples may include polythio-ether-polyols, polyester-amides, hydroxyl-containing polyacetals and hydroxyl-containing aliphatic polycarbonates. Other selections may include mixtures of at least two of the above-mentioned polyhydroxyl and polyamine compounds.

Suitable polyester polyols may be prepared from, for example, organic dicarboxylic acids having from about 2 to about 12 carbon atoms, preferably aromatic dicarboxylic acids having from 8 to 12 carbon atoms and polyhydric alcohols, preferably diols having from 2 to 12 carbon atoms, preferably from 2 to 6 carbon atoms. Examples of suitable dicarboxylic acids are succinic acid, glutaric acid, adipic acid, suberic acid, azelaic acid, sebacic acid, decanedicarboxylic acid, maleic acid, fumaric acid, and preferably phthalic acid, isophthalic acid, terephthalic acid and the isomeric naphthalene-discarboxylic acids. The dicarboxylic acids may be used either individually or mixed with one another. The free dicarboxylic acids may also be replaced by the corresponding dicarboxylic acid derivatives, for example, dicarboxylic esters of alcohols having 1 to 4 carbon atoms or diarboxylic anhydrides. Preference is given to dicarboxylic acid mixtures comprising succinic acid, glutaric acid and adipic acid in ratios of, for example, from 20 to 35:35 to 50:20 to 32 parts by weight, and adipic acid, and in particular mixtures of phthalic acid and/or phthalic anhydride and adipic acid, mixtures of phthalic acid or phthalic anhydride, isophthalic acid and adipic acid or dicarboxylic acid mixtures of succininc acid, glutaric acid and adipic acid and mixtures of terephthalic acid and adipic acid or dicarboxylic acid mixtures of succinic acid, glutaric acid and adipic acid. Examples of dihydric and polyhydric alcohols, in particular diols, are ethanediol, diethylene glycol, 1,2- and 1,3-propanediol, dipropylene glycol, 1,4-butanediol, 1,5-pentanediol, 1,6-hexanediol, 1,10-decanediol, glycerol, trimethylolpropane. Preference is given to ethanediol, diethylene glycol, 1,4-butanediol, 1,5-pentanediol, 1,6-hexanediol or mixtures of at least two of said diols, in particular mixtures of 1,4-butanediol, 1,5-pentanediol and 1,6-hexanediol. Furthermore, polyester-polyols made from lactones, e.g., ε-caprolactone or hydroxycarboxylic acids, e.g., ω-hydroxycaproic acid and hydrobenzoic acid, may also be employed.

The polyester polyols may be prepared by polycondensing the organic, e.g., aliphatic and preferably aromatic polycarboxylic acids and mixtures of aromatic and aliphatic polycarboxylic acids, and/or derivatives thereof, and polyhydric alcohols without using a catalyst or preferably in the presence of an esterification catalyst, expediently in an inert gas atmosphere, e.g., nitrogen, carbon monoxide, helium, argon, inter alia, in the melt at from about 150° C. to about 250° C., preferably from 180° C. to 220° C., at atmospheric pressure or under reduced pressure until the desired acid number, which is advantageously less than 10, preferably less than 2, is reached. In a preferred embodiment, the esterification mixture is polycondensed at the abovementioned temperatures under atmospheric pressure and subsequently under a pressure of less than 0.5 bar (50,000 N/m²), preferably from 0.05 bar to 0.150 bar (5,000 N/m²to 15,000 N/m²), until an acid number of from 80 to 30, preferably from 40 to 30, has been reached. Examples of suitable esterification catalysts are iron, cadmium, cobalt, lead, zinc, antimony, magnesium, titanium and tin catalysts in the form of metals, metal oxides or metal salts. However, the polycondensation may also be carried out in the liquid phase in the presence of diluents and/or entrainers, e.g., benzene, toluene, xylene or chlorobenzene, for removal of the water of condensation by azeotropic distillation.

The polyester polyols are advantageously prepared by polycondensing the organic polycarboxylic acids and/or derivatives thereof with polyhydric alcohols in a molar ratio of from 1:1 to 1:1.8, preferably from 1:1.05 to 1:1.2. The polyester polyols preferably have a functionality of from 2 to 3 and a hydroxyl number of from 150 to 600, in particularly, from 200 to 400.

One group of readily available polyhydroxyl compounds includes the polyether polyols. These may be prepared by known processes, for example, by anionic polymerization using alkali metal hydroxides such as sodium hydroxide or potassium hydroxide, or alkali metal alkoxides, such as sodium methoxide, sodium ethoxide, potassium ethoxide or potassium isopropoxide as catalyst and with addition of at least one initiator molecule containing from 2 to 8, preferably 3 to 8, reactive hydrogen atoms in bound form or by cationic polymerization using Lewis acids, such as antimony pentachloride, boron bluoride etherate, inter alia, or bleaching earth as catalysts, from one or more alkylene oxides having from 2 to 4 carbon atoms in the alkylene moiety.

Examples of suitable alkylene oxides are tetrahydrofuran, 1,3-propylene oxide, 1,2- and 2,3-butylene oxide, styrene oxide and preferably ethylene oxide and 1,2-propylene oxide. The alkylene oxides may be used individually, alternatively one after the other, or as mixtures. Examples of suitable initiator molecules are water, organic dicarboxylic acids such as succinic acid, adipic acid, phthalic acid and terephthalic acid, and a variety of amines, including but not limited to aliphatic and aromatic, unsubstituted or N-mono-, N,N- and N,N′-dialkyl-substituted diamines having from 1 to 4 carbon atoms in the alkyl moiety, such as unsubstituted or mono- or dialkyl-substituted ethylenediamine, diethylenetriamine, triethylenetetramine, 1,3-propylene-diamine, 1,3- and 1,4-butylene diamine, 1,2-, 1,3-, 1,4-, 1,5- and 1,6-hexamethylenediamine, aniline, phenylenediamines, 2,3-, 2,4-, 3,4- and 2,6-tolylenediamine and 4,4′-, 2,4′- and 2,2′-diaminodiphenylmethane.

Other suitable initiator molecules are alkanolamines, e.g., ethanolamine, N-methyl- and N-ethylethanolamine, dialkanolamines, e.g., diethanolamine, N-methyl- and N-ethyldi-ethanolamine, and trialkanolamines, e.g., triethanolamine, and ammonia, and polyhydric alcohols, in particular dihydric and/or trihydric alcohols, such as ethanediol, 1,2- and 1,3-propanediol, diethylene glycol, dipropylene glycol, 1,4-butanediol, 1,6-hexanediol, glycerol, trimethylolpropane, pentaerythritol, sorbitol and sucrose, polyhydric phenols, for example, 4,4′-dihydroxy-diphenylmethane and 4,4′-dihydroxy-2,2-diphenylpropane, resols, for example, oligomeric products of the condensation of phenol and formaldehyde, and Mannich condensates of phenols, formaldehyde and dialkanolamines, and melamine.

It is advantageous in some embodiments that the polyols included in the polyol system are polyether polyols having a functionality of from 2 to 8 and a hydroxyl number of from 100 to 850 prepared by anionic polyaddition of at least one alkylene oxide, preferably ethylene oxide or 1,2-propylene oxide or 1,2-propylene oxide and ethylene oxide, onto, as initiator molecule, at least one aromatic compound containing at least two reactive hydrogen atoms and containing at least one hydroxyl, amino and/or carboxyl group. Examples of such initiator molecules are aromatic polycarboxylic acids, for example, hemimellitic acid, trimellitic acid, trimesic acid and preferably phthalic acid, isophthalic acid and terephthalic acid, or mixtures of at least two said polycarboxylic acids, hydroxycarboxylic acids, for example, salicylic acid, p- and m-hydroxybenzoic acid and gallic acid, aminocarboxylic acids, for example, anthranilic acid, m- and p-aminobenzoic acid, polyphenols, for example, resorcinol, and preferably dihydroxydiphenyl-methanes and dihydroxy-2,2-diphenylpropanes,

Mannich condensates of phenols, formaldehyde and dialkanolamines, preferably diethanolamine, and preferably aromatic polyamines, for example, 1,2-, 1,3- and 1,4-phenylenediamine and in particular 2,3-, 2,4-, 3,4- and 2,6-tolylenediamine, 4,4′-, 2,4′- and 2,2′-diamino-diphenylmethane, polyphenyl-polymethylene-polyamines, mixtures of diamino-diphenylmethanes and polyphenyl-polymethylene-polyamines, as formed, for example, by condensation of aniline with formaldehyde, and mixtures of at least two of said polyamines.

The preparation of polyether polyols using at least difunctional aromatic initiator molecules of this type is known and described in, for example, DD-A-290 201; DD-A-290 202; DE-A-34 12 082; DE-A-4 232 970; and GB-A-2,187,449, which are incorporated herein by reference in their entireties.

The polyether polyols preferably have a functionality of from 3 to 8, in particular from 3 to 7, and hydroxyl numbers of from 120 to 770, in particular from 200 to 650.

Other suitable polyether polyols are melamine/polyether polyol dispersions as described in EP-A-23 987 (U.S. Pat. No. 4,293,657), polymer/polyether polyol dispersions prepared from polyepoxides and epoxy resin curing agents in the presence of polyether-polyols, as described in DE 29 43 689 (U.S. Pat. No. 4,305,861), dispersions of aromatic polyesters in polyhydroxyl compounds, as described in EP-A-62 204 (U.S. Pat. No. 4,435,537) and DE-A 33 00 474, dispersions of organic and/or inorganic fillers in polyhydroxyl compounds, as described in EP-A-11 751 (U.S. Pat. No. 4,243,755), polyurea/polyether-polyol dispersions, as described in DE-A-31 25 402, tris(hydroxyalkyl) isocyanurate/polyether-polyol dispersions, as described in EP-A-136 571 (U.S. Pat. No. 4,514,426), and crystallite suspensions, as described in DE-A-33 42 176 and DE-A-33 42 177 (U.S. Pat. No. 4,560,708), these patent publications being incorporated herein in their entireties by reference. Other types of dispersions that may be useful in the present invention include those wherein nucleating agents, such as liquid perfluoroalkanes and hydrofluoroethers, and inorganic solids, such as unmodified, partially modified and modified clays, including, e.g., spherical silicates and aluminates, flat laponites, montmorillonites and vermiculites, and particles comprising edge surfaces, such as sepiolites and kaolinite-silicas. Organic and inorganic pigments and compatibilizers, such as titanates and siliconates, may also be included in useful polyol dispersions.

Like the polyester polyols, the polyether-polyols may be used individually or in the form of mixtures. Furthermore, they may be mixed with the graft polyether polyols or polyester polyols and the hydroxyl-containing polyester-amides, polyacetals, polycarbonates and/or phenolic polyols.

Examples of suitable hydroxyl-containing polyacetals are the compounds which may be prepared from glycols, such as diethylene glycol, triethylene glycol, 4,4′-dihydroxyethoxy-diphenyldimethylmethane, hexanediol and formaldehyde. Suitable polyacetals can also be prepared by polymerizing cyclic acetals.

Suitable hydroxyl-containing polycarbonates are those of a conventional type, which can be prepared, for example, by reacting diols, such as 1,3-propanediol, 1,4-butanediol and/or 1,6-hexanediol, diethylene glycol, triethylene glycol or tetraethylene glycol, with diaryl carbonates, e.g., diphenyl carbonate, or phosgene.

The polyester-amides include, for example, the predominantly linear condensates obtained from polybasic, saturated and/or unsaturated carboxylic acids or anhydrides thereof and polyhydric, saturated and/or unsaturated amino alcohols, or mixtures of polyhydric alcohols and amino alcohols and/or polyamines.

Suitable compounds containing at least two reactive hydrogen atoms are furthermore phenolic and halogenated phenolic polyols, for example, resol-polyols containing benzyl ether groups. Resol-polyols of this type can be prepared, for example, from phenol, formaldehyde, expediently paraformaldehyde, and polyhydric aliphatic alcohols. Such are described in, for example, EP-A-0 116 308 and EP-A-0 116 310, which are incorporated herein by reference in their entireties.

In certain preferred embodiments, the isocyanate-reactive component may include a mixture of polyether polyols containing at least one polyether polyol based on an aromatic, polyfunctional initiator molecule and at least one polyether polyol based on a non-aromatic initiator molecule, preferably a trihydric to octahydric alcohol.

In order to expedite and facilitate the elastomer-forming reaction, one or more catalysts are desirably included in the formulation. Where a foam is being prepared, it may be desirable to include, in particular, a catalyst that favors the urea (blowing) reaction. Examples of such catalysts may include bis-(2-dimethylaminoethyl)ether; tris(dialkylaminoalkyl)-s-hexahydrotriazines such as 1,3,5-tris-(N,N-dimethylaminopropyl)-s-hexahydrotriazine; penta-methyldiethylenetriamine; tetra-alkylammonium hydroxides such as tetramethylammonium hydroxide; alkali metal hydroxides such as sodium hydroxide; alkali metal alkoxides such as sodium methoxide and potassium isopropoxide; and alkali metal salts of long-chain fatty acids having 10 to 20 carbon atoms and, in some embodiments, pendant hydroxyl groups. In one embodiment, a combination of bis(dimethylaminoethyl)ether and dipropylene glycol may be an effective blowing catalyst, for example, in a 70/30 weight percent ratio. Combinations of any of the above may also be selected.

Examples of suitable catalysts that may tend to favor the urethane (gel) reaction, which may be particularly useful for both foamed and non-foamed formulations, include, generally, amidines, tertiary amines, organometallic compounds, and combinations thereof. These may include, but are not limited to, amidines such as 1,8-diazabicyclo [5.4.0]undec-7-ene and 2,3-dimethyl-3,4,5,6-tetrahydropyrimidine, and tertiary amines such as triethylamine, tributylamine, dimethylbenzylamine, N-methyl-, N-ethyl-, and N-cyclohexylmorpholine, N,N,N′,N′-tetra-methylethylenediamine, N,N,N′,N′-tetramethyl-butanediamine and -hexanediamine, pentamethyldiethylenetriamine, tetramethyldiaminoethyl ether, bis(dimethylamino-propyl)urea, dimethylpiperazine, dimethylcyclohexylamine, 1,2-dimethyl-imidazole, 1-aza-bicyclo[3.3.0]octane, and, in some preferred embodiments, 1,4-diaza-bicyclo[2.2.2]octane. Alkanolamine compounds, such as triethanolamine, triisopropanolamine, N-methyl- and N-ethyldiethanolamine, and dimethylethanolamine may also be selected. Combinations of any of the above may also be effectively employed.

Organometallic compounds may include organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate. Bismuth salts of organic carboxylic acids may also be selected, such as, for example, bismuth octanoate. The organometallic compounds based on mercury, lead, and zinc may also be useful. Mercury catalysts, such as mercury carboxylates including, but not limited to, phenylmercuric neodeconate, are particularly effective catalysts for polyurethane elastomer, coating and sealant applications, since they are highly selective toward the urethane (gel) reaction. They may be used at low levels to give systems a long pot life while still providing excellent back-end cure. Lead catalysts may be useful in highly reactive rigid spray foam insulation applications, since they maintain their potency in low-temperature and high-humidity conditions. However, the known toxicity of mercury- and lead-based materials, as well as the disposal challenges and, in some countries, hazardous material classifications of these materials, should be taken into account in selecting a suitable formulation. Selections from this category of catalysts may be used alone or in combinations, or, in some embodiments, in combination with one or more of the highly basic amines listed hereinabove. In one particular embodiment, the combined amount of the urethane-favoring and urea-favoring catalysts is greater than about 1.7 percent, based on the weight of the polyol system.

In addition to the previously discussed components, the formulation may include additional, optional components. Among these may be chain extenders and/or crosslinking agents, which, unlike the polyols, are not polymers in their own right. Chain extenders are used to join together lower molecular weight polyurethane chains in order to form higher molecular weight polyurethane chains, and are generally grouped as having a functionality equal to 2. Crosslinking agents serve to promote or regulate intermolecular covalent or ionic bonding between polymer chains, linking them together to create a more rigid structure. The crosslinking agents are generally grouped as having a functionality equal to 3 or more. Both of these groups are usually represented by relatively short chain or low molecular weight molecules such as hydroquinone di(β-hydroxyethyl)ether, natural oil polyols (NOP) containing reactive hydroxyl groups, such as castor oil, glycerine, ethylene glycol (EG), diethylene glycol (DEG), triethylene glycol, tetraethylene glycol, propylene glycol, dipropylene glycol, tripropylene glycol, 1,3-propane-diol, 1,3-butanediol, 1,4-butanediol (BDO), neopentyl glycol, 1,6-hexanediol, 1,4-cyclo-hexanedimethanol, ethanolamine, diethanolamine, methyldiethanolamine, phenyldiethanolamine, glycerol, trimethylolpropane (TMP), 1,2,6-hexanetriol, triethanol-amine,pentaerythritol, N,N,N′,N′-tetrakis(2-hydroxypropyl)-ethylenediamine, diethyl-toluenediamine, dimethylthiotoluene-diamine, combinations thereof, and the like. Particularly frequently used are 1,4-butanediol (BDO), diethylene glycol (DEG), glycerine, 1,4-trimethylolpropane (TMP), and combinations thereof. Some molecules may contribute to both chain extension and crosslinking. Those skilled in the art will be familiar with a wide range of suitable chain extenders and/or crosslinking agents.

However, notwithstanding the above, it should be noted that where a butanediol, e.g., 1,3-butanediol or 1,4-butanediol, is selected as a chain-extender and/or cross-linker, it is preferred that the butanediol not be included in the prepolymer. This is because the carbon black may be in some embodiments relatively incompatible with butanediol. Thus, inclusion of the butanediol in the prepolymer may disrupt formation of the prepolymer and/or formation of the conductive pathway by the aggregated particulate carbon black used in the invention.

Additional formulation components may optionally be included, according to the desire of the practitioner. Such may include, in non-limiting embodiments, pigments and colorants; flame retardants; antioxidants; surface modifiers; surfactants; bioretardant agents; mold release agents; viscosity modifiers; plasticizers; and combinations thereof.

In forming the elastomers of the invention, it is desirable to first form a prepolymer. Reacting a polyol (i.e., a part of the isocyanate-reactive component) with an excess of isocyanate component (which, in preferred embodiments, is all of the isocyanate component) produces a prepolymer having free terminal isocyanate groups, which may then be reacted with the remainder of the isocyanate-reactive component. A quasi-prepolymer is formed when the stoichiometric ratio of isocyanate groups to hydroxyl or amine groups is greater than 2:1. A true prepolymer is formed when the stoichiometric ratio is equal to 2:1. The present invention requires that the aggregated particulate carbon black is incorporated into the prepolymer such that the prepolymer has a volume resistivity ranging from 1×10⁴ to 1×10⁸ ohms (1×10⁻⁴ to 1×10⁻⁸ siemens (mho)). In order to accomplish this the carbon black is generally employed in an amount ranging from 0.3 percent (%) to 5%, more desirably from 0.3% to 1%, based on the weight of the isocyanate component. Furthermore, it is desirable that the total amount of prepolymer is such that, when it is combined with the remainder of the isocyanate-reactive component, the prepolymer, containing the aggregated particulate carbon black, forms the continuous phase in the two-phase system. In this system the carbon black is dispersed such that a structure is formed, referred to herein as a “percolated structure.” In order to ensure this, it is first necessary to accomplish the dispersal of the carbon black in the prepolymer and, subsequently, in the formulation. The nature of the carbon black generally assures that the structure formation, i.e., formation of the conductive pathway, is not disrupted even by use of relatively high shear mixing techniques such as those resulting from, in non-limiting example, use of a rotor/stator mixing device or homogenizer. Nonetheless, where testing shows that the desired level of conductivity has not been achieved using the methodology described herein, it may be necessary for the skilled practitioner to reduce the shear effect in order to ensure that the structure formation is established and maintained.

Once the formulation components have been mixed, they are introduced into a mold or cavity, or onto a substrate, in any way known in the art to produce a polyurethane elastomer or polyurethane foam. It is noted that in certain applications foaming may be carried out under conditions suitable to ensure that the final product is a particular type of foam, such as a microcellular foam or a slabstock or molded closed- or open-celled foam. Those skilled in the art will be aware of various types of apparatus to accomplish the contact while ensuring that an adequate level of mixing occurs to ensure uniformity of the final elastomer. One way to do this is to use a mixing injection head, wherein the two “sides” of the formulation (the isocyanate-terminated prepolymer containing the carbon black, and the remaining isocyanate-reactive component) are combined and mixed and then, more or less simultaneously, injected into the mold or cavity to be filled. The so-called “one shot” injection, wherein the mold or cavity is filled from a single injection point while simultaneously drawing a vacuum from another point, may be particularly desirable. Where a mold is used, demolding may be carried out using standard methodologies, and where desirable, suitable external and/or internal mold release agents may be employed.

The final polyurethane elastomer desirably exhibits enhanced capability to dissipate static electricity, i.e., it has a surface resistivity ranging from 1×10⁴ to 1×10⁸ ohms (1×10⁻⁴ to 1×10⁻⁸ siemens (mho)), and in preferred embodiments, from 1×10⁴ to 1×10⁶ ohms (1×10⁻⁴ to 1×10⁻⁶ siemens (mho)). It may also exhibit other desirable properties, such as, for example, for an elastomer having a density of 1.23 grams per milliliter (g/mL): a Shore A hardness of from 70 to 80; a 100% modulus of at least 3.5 megapascals (MPa); a 300% modulus of at least 7.5 MPa; a tensile strength of at least 20 MPa; an elongation at break of at least 400%; a nicked crescent tear strength of at least 30 newtons per millimeter (N/mm); a split tear strength of at least 9 N/mm; a compression set after 22 hours at 70° C. of at least 30%; an abrasion of less than 80 cubic millimeters (mm³) loss; a flame retardance of “Pass VO” (6 mm sample; and/or a rebound resilience of at least 28%. Test values provided in this paragraph are based on the standards protocols identified in Table 5.

### EXAMPLES

The following materials are used in all Examples and Comparative Examples.
Component A—DIOREZ™ 8035, a saturated polyester polyol having a functionality of 2, molecular weight of 1,700, which is 2-methyl-1,3-propanediol. DIOREZ™ is a trademark of Dow Hyperlast, Ltd.
Component B—Para-nitrobenzoyl chloride, added at 0.1 percent of total prepolymer weight.
Component C—ISONATE™ M125, diphenylmethane diisocyanate, containing approximately 97 percent 4,4-diphenyl-methane diisocyanate and 3 percent 2,4′-diphenyl-methane diisocyanate, added at 40 percent of total prepolymer weight. ISONATE™ is a trademark of The Dow Chemical Company.
Component D—ISONATE™ M143 is a modified diisocyanate containing a high percentage of pure diphenyl-pmethane diisocyanate, added at 10 percent of total Prepolymer weight.
Component E—Kletjenblack™ EC-600-JD is an aggregated particulate carbon black product having an average particle diameter ranging from 30 nm to 100 nm.
Component F—DIOREZ™ 687, a saturated polyester polyol having a functionality of 2, molecular weight of 1,000, which is an ethylene/butane/neopentyl adipate. DIOREZ™ is a trademark of Dow Hyperlast, Ltd.
Component G—BYK™ 085 is polymethyl alkyl siloxane, available from BYK Chemie.
Component H—1,4-butanediol is a chain extender.
Component I—UOP L Powder, a Type A Zeolite powder, available from UOP, LLC.
Component J—THORCAT™ 535 is a phenyl mercuric neodecanoate in neodecanoic acid catalyst.
Component K—EXOLIT™ AP 422 is a fine particle ammonium polyphosphate flame retardant powder. EXOLIT™ is a trademark of Clariant International, Ltd.
Component L—PENNWHYTE™ Silicone Oil 47-V-50 is a general purpose silicone oil, available from Penn Whyte, Ltd.
Component M—DIOREZ™ PR3 is a saturated, branched polyester polyol having a molecular weight of 2,000, based on ethylene-propylene adipate.

### Example 1

A prepolymer is prepared by charging Component A into a stainless steel reactor. The reactor contents are then dehydrated to less than 0.04% water, based on the weight of the Component A, by heating at a temperature of 120 degrees Celsius (° C.) for 120 minutes, under vacuum. The water content is rechecked, dehydration continued if necessary, otherwise the reactor contents are then cooled to 50° C. Component B is then added. The reactor contents are then further cooled to 50° C. and Component C is charged. The reactor contents are allowed to react for 2 hours at 75° C. Component D is then charged and the reactor contents cooled to 50° C. The result is a prepolymer intermediate, and proportions of each component are shown in Table 1. Testing by means of a potentiometric or wet titration technique using di-n-butylamine shows an NCO content of 14.0% and a viscosity of 15 Poise at 50° C.

TABLE 1

| Component | % Weight |
|---|---|
| Component A | 49.292 |
| Component B | 0.005 |
| Component C | 40.562 |
| Component D | 10.141 |

In a second step, the Component E is combined with the prepolymer intermediate and dispersed crudely therein, using a paddle-type mixer. The reactor contents are then flowed several times through a shear type mixer until Component E is fully dispersed. The viscosity at this point is determined to be 20 poise (P) (2 pascal·seconds, Pa·s) at 50° C., as measured by an ICI Cone and Plate Viscometer. Table 2 shows the proportions of the prepolymer intermediate and Component E in the final prepolymer containing the particulate carbon black.

TABLE 2

| Component | % Weight |
|---|---|
| Prepolymer | 99.0041 |
| Intermediate | |
| Component E | 0.9959 |

The final prepolymer is tested and determined to have a resistivity of approximately 1.0×10⁴ ohms. The prepolymer is maintained at a temperature of from 30° C. to 50° C., and a formulated polyol, including Components F-L, is prepared, including the components and proportions shown in Table 3. The formulated polyol is brought to a temperature of from 40° C. to 60° C., and then combined and reacted with the formulated polyol to form an elastomeric polyurethane. Table 3 also shows the formulated polyol's theoretical hydroxyl value and the ratio of the formulated polyol to the final prepolymer.

TABLE 3

| Component | A¹ |
|---|---|
| Component F | 78.280 |
| Component G | 0.020 |
| Component H | 8.000 |
| Component I | 1.700 |
| Component J | 0.300 |
| Component K | 11.200 |
| Component L | 0.500 |
| Theoretical Hydroxyl | 187.3 |
| Value (mg KOH/g) | |
| Mix Ratio² | 0.97:1.00 |
| Gel Time (minutes) | 5-7 |
| Demold Time | 40 |
| (minutes) | |

¹Percentage as measured using a meter in compliance with BS EN ISO 868.
²Mix ratio of isocyanate-reactive component with the prepolymer.

The completed formulation, including both final prepolymer and formulated polyol, is poured or cast into a mold that has been preheated to 80° C. and allowed to react. Gel time is determined and the polyurethane elastomer is then demolded. Gel and demold times are recorded in Table 3. Table 4 shows the physical properties of the polyurethane elastomer.

TABLE 4

| Physical Property | Test Method | Value |
|---|---|---|
| Hardness (Shore A) | BS EN¹ ISO 868 | 75 |
| Density (g/mL) | BS² 903 Pt A1 | 1.23 |
| 100% Modulus (MPa) | BS 903 Pt A2 | 3.8 |
| 300% Modulus (MPa) | BS 903 Pt A2 | 8.2 |
| Tensile Strength (MPa) | BS 903 Pt A2 | 24 |
| Elongation at Break (%) | BS 903 Pt A2 | 500 |
| Nicked Crescent Tear Strength | ASTM³ D624 | 36 |
| (N/mm) | | |
| Split Tear Strength (N/mm) | ASTM D470 | 10.5 |
| Compression Set (%) 22 hr at 70° C. | ASTM D395 | 38 |
| Abrasion (mm³ loss) | DIN⁴ 53516 | 70 |
| Flame Retardant (6 mm) | UL 94⁵ (6 mm | Pass V0 |
| | thick) | |
| Surface Resistivity (ohms) | BS EN 20284 | <1.0 × 10⁵ |
| Rebound Resilience (%) | BS 903 Pt A8 | 32 |

¹British-Adopted European [Committee for Standardization] Standard
²British Standard
³American Society for Testing Materials Standard
⁴German Institute for Standardization Standard
⁵Underwriting Laboratories Test

### Example 2

Using the procedures of Example 1, a second preparation is made, but the Component E is first dispersed in Component A in the stainless steel reactor. The reactor contents are then dehydrated to less than 0.04% water, based on the weight of the Component A, by heating at a temperature of 120 degrees Celsius (° C.) for 120 minutes, under vacuum. The water content is rechecked, dehydration continued if necessary, otherwise the reactor contents are then cooled to 50° C. Component B is then added and the remainder of Example 1 is then followed.

### Example 3 and Comparative Examples A and B

Following the procedures of Example 1, three comparative polyurethane elastomers are prepared, using the same components as in Example 1, but not including Component L, and further including Component M, which is combined into the formulated polyols with Components F-K. The differences, however, are that in Example 3 the carbon black (Component E) is incorporated first in Component F and then, with Component F, in the prepolymer; in Comparative Example A Component E is incorporated first in Component F and then, with Component F, partly in the prepolymer and partly in the non-prepolymer formulated polyol; and in Comparative Example B it is incorporated first in Component F and then, with Component F, only in the non-prepolymer formulated polyol. The formulated polyol proportions are shown in Table 5, and testing is carried out, with results recorded in Table 5. Table 5 demonstrates the improvement obtained where the carbon black is dispersed in the prepolymer phase. The results below show that when the carbon black is dispersed in the prepolymer, the anti-static properties of the elastomer remain stable over a period of time. When the carbon black is, instead, dispersed in the polyol phase, the anti-static properties diminish over time.

TABLE 5

| | | Comparative | Comparative |
|---|---|---|---|
| Component | Example 3 | Example A | Example B |
| Component F | 68.95 | 42.59 | 28.95 |
| Component M | 11.04 | 11.04 | 11.04 |
| 2.5% Component E in | — | 26.63 | 40.00 |
| Component F | | | |
| Component G | 0.11 | 0.11 | 0.11 |
| Component H | 6.63 | 6.63 | 6.63 |
| Component I | 1.66 | 1.66 | 1.66 |
| Component J | 0.28 | 0.28 | 0.28 |
| Component K | 11.33 | 11.33 | 11.33 |
| Hardness (Shore A) | 75 | 75 | 75 |
| Component E-containing part | Prepolymer | Both | Polyol only |
| (prior to reaction of pre- | only | prepolymer | |
| polymer and polyol) | | and polyol | |
| Calculated Component E | 0.38 | 0.56 | 0.56 |
| loading in cast elastomer | | | |
| Initial Surface Resistivity | 4.4 × 10⁵ | 1.09 × 10⁵ | 1.0 × 10⁵ |
| (ohms) | | | |
| Surface Resistivity after | 2.4 × 10⁵ | 2.2 × 10⁶ | 3 × 10⁷ |
| 8 weeks | | | |

What is claimed is:

1. A semi-conductive polyurethane elastomer, comprising at least 0.3 percent by weight of an aggregated particulate carbon black, having an average particle diameter that is less than or equal to 100 nanometers, that forms a conductive pathway within the polyurethane elastomer, the polyurethane elastomer having been prepared by incorporating the aggregated particulate carbon black into an isocyanate-terminated prepolymer, such that the polyurethane elastomer has a surface resistivity of from 1×10⁴ to 1×10⁸ ohms

2. The polyurethane elastomer of claim 1, wherein the carbon black is selected from Ketjenblack™ EC-600JD, Ketjenblack™ EC-330JMA, and combinations thereof

3. The polyurethane elastomer of claim 1, wherein the carbon black is present in an amount from 0.3 percent by weight to 5 percent by weight.

4. The polyurethane elastomer of claim 1, wherein the carbon black has a particle size from 30 to 100 nanometers.

5. The polyurethane elastomer of claim 1, wherein the carbon black has additional properties including at least one of an apparent bulk density of less than 200 kilograms per cubic meter, a pore volume of at least 300 milliliters per 100 grams, an iodine absorption of at least 700 milligrams per gram, and a Brunauer, Emmett, Teller (BET) surface area of at least 800 square meters per gram.

6. The polyurethane elastomer of claim 1, wherein the polyurethane elastomer exhibits a surface resistivity of from 1×10⁴ to 1×10⁶ ohms

7. A process for preparing a semi-conductive polyurethane elastomer comprising the steps of (a) preparing an isocyanate-terminated prepolymer wherein at least 0.3 percent by weight of an aggregated particulate carbon black, having an average particle diameter that is less than or equal to 100 nanometers, is incorporated in the prepolymer, the prepolymer having a volume resistivity of from 1×10⁴ to 1×10⁸ ohms; and (b) reacting the isocyanate-terminated prepolymer and an isocyanate-reactive component to form a polyurethane elastomer prepolymer having a surface resistivity of from 1×10⁴ to 1×10⁸ ohms; the isocyanate-terminated prepolymer and the isocyanate-reactive component being in proportions such that the isocyanate-terminated prepolymer forms a continuous phase and the isocyanate-reactive component forms a discontinuous phase; under conditions such that the aggregated particulate carbon black forms a conductive pathway in the polyurethane elastomer.

8. The process of claim 7, wherein the carbon black is selected from Ketjenblack™ EC-600JD, Ketjenblack™ EC-330JMA, and combinations thereof

9. The process of claim 7, wherein the carbon black is present in an amount from 0.3 percent by weight to 5 percent by weight.

10. The process of claim 7 wherein the carbon black has a particle size from 30 to 100 nanometers.

11. The process of claim 7 wherein the carbon black has additional properties including at least one of an apparent bulk density of less than 200 kilograms per cubic meter, a pore volume of at least 300 milliliters per 100 grams, an iodine absorption of at least 700 milligrams per gram, and a Brunauer, Emmett, Teller (BET) surface area of at least 800 square meters per gram.

12. The process of claim The polyurethane elastomer of claim 7, wherein the polyurethane elastomer exhibits a surface resistivity of from 1×10⁴ to 1×10⁶ ohms
